(19) United States
(12) Patent Application Publication
(10) Pub. No.: US 2008/0138478 A1
(43) Pub. Date: Jun. 12, 2008

(54) Vacuum packaging of a meat product using a film having a carbon dioxide scavenger

(75) Inventors: Cynthia L. Ebner, Greer, SC (US); Walker Stockley, Spartanburg, SC (US)

Correspondence Address: Mark B. Quatt;Sealed Air Corporation, P.O. Box 464, Duncan, SC, 29334, US

(73) Assignee: Cryovac, Inc.

(21) Appl. No.: 11/637,499

(22) Filed: Dec. 12, 2006

(51) Int. Cl. B65B 25/06; B32B 27/32; B65B 53/00

(52) U.S. Cl. 426/415; 428/35.7; 428/34.9

(57) ABSTRACT

A package includes a vacuumized bag made from a film including an outer layer including an olefin polymer or copolymer, an inner layer including an olefin polymer or copolymer, an oxygen barrier layer, disposed between the outer and inner layer, including a polymer or copolymer having an oxygen permeability of less than 100 cm³ O₂/m²·day·atmosphere, and an intermediate layer, disposed between the oxygen barrier layer and inner layers, including a polymer or copolymer, wherein at least one of the inner and intermediate layers includes a carbon dioxide scavenger; and a meat product disposed in the bag. A method of packaging a meat product includes providing a bag made from the above film; putting a meat product into the bag through an open bag mouth; drawing a vacuum on the bag to provide a vacuumized bag; and heat sealing the open mouth of the bag.

### FIELD OF THE INVENTION

The present invention relates to the vacuum packaging of a meat product using a film having a carbon dioxide scavenger.

### BACKGROUND OF THE INVENTION

Perishable goods such as meats are sometimes packaged to exclude oxygen and are sometimes flushed with suitable gases such as carbon dioxide in order to increase the quantity of the gases dissolved in the product and to extend the shelf-life and decontaminate the product. Vacuum packaging in heat sealable plastic bags is another conventional way of packaging food items such as meat, e.g. fresh red meat. Vacuum packaging typically involves placing the food item in a heat sealable plastic bag and then evacuating air from the bag and thus collapsing it about the contained food item. The bag is then heat sealed in its evacuated condition so the food item becomes encased in a generally air-free environment. Typically, the bag is a heat shrinkable bag, and after the heat sealing step, is advanced to a hot water or hot air shrink tunnel to induce shrinkage of the bag around the food item.

Certain cuts of vacuum packaged meats have been found to develop gas bubbles with aging. The bubbles become visible as white spots between the meat and the packaging film, especially over the fat portion of the meat, and detract from the overall appearance of the vacuum package. The presence of the bubbles does not indicate the item is spoiled, but is unattractive and may cause a consumer to reject the package. It has been found that these bubbles are composed primarily of carbon dioxide. The source of the carbon dioxide in a non-gas flushed package is uncertain, and may be due to passive diffusion from the meat muscle, from an enzymatic process, or from microbial growth at the meat surface.

There is a continuing need for food packaging materials and methods for their preparation and use that will reduce the formation of the carbon dioxide bubbles within a vacuumized package, especially to improve the package appearance.

### SUMMARY OF THE INVENTION

In a first aspect, a package comprises a vacuumized bag, the bag made from a film comprising an outer layer comprising an olefin polymer or copolymer, an inner layer comprising an olefin polymer or copolymer, an oxygen barrier layer, disposed between the outer and inner layers, comprising a polymer or copolymer having an oxygen permeability of less than 100 cm³ O₂/m²·day·atmosphere (ASTM D3985), and an intermediate layer, disposed between the oxygen barrier layer and the inner layer, comprising a polymer or copolymer, wherein at least one of the inner layer and intermediate layer comprises a carbon dioxide scavenger; and a meat product disposed in the vacuumized bag.

In one embodiment, the package comprises a vacuumized, heat sealed bag, the bag made from a tubular film comprising an outer layer comprising an olefin polymer or copolymer, an inner layer comprising an olefin polymer or copolymer, an oxygen barrier layer, disposed between the outer and inner layers, comprising ethylene/vinyl alcohol copolymer, a first intermediate layer, disposed between the oxygen barrier layer and the inner layer, the first intermediate layer comprising a polyamide, a second intermediate layer, disposed between the oxygen barrier layer and the outer layer, the second intermediate layer comprising a polyamide, a first tie layer, disposed between the first intermediate layer and the inner layer, the first tie layer comprising an anhydride grafted polymer or copolymer, and a second tie layer, disposed between the second intermediate layer and the outer layer, the second tie layer comprising an anhydride grafted polymer or copolymer, wherein at least one of the inner layer, first tie layer, and first intermediate layer comprises a carbon dioxide scavenger; and a fresh red meat product disposed in the vacuumized bag.

In a second aspect, a method of packaging a meat product comprises providing a bag, the bag made from a film comprising an outer layer comprising an olefin polymer or copolymer, an inner layer comprising an olefin polymer or copolymer, an oxygen barrier layer, disposed between the outer and inner layers, comprising a polymer or copolymer having an oxygen permeability of less than 100 cm³ O₂/m²·day·atmosphere (ASTM D3985), and an intermediate layer, disposed between the oxygen barrier layer and the inner layer, the intermediate layer comprising a polymer or copolymer, wherein at least one of the inner layer and intermediate layer comprises a carbon dioxide scavenger; putting a meat product into the bag through an open mouth of the bag; drawing a vacuum on the bag to provide a vacuumized bag; and heat sealing the open mouth of the bag to provide a hermetic, vacuumized bag.

In one embodiment, the method of packaging a meat product comprises providing a bag, the bag made from a tubular film comprising an outer layer comprising an olefin polymer or copolymer, an inner layer comprising an olefin polymer or copolymer, an oxygen barrier layer, disposed between the outer and inner layers, comprising ethylene/vinyl alcohol copolymer, a first intermediate layer, disposed between the oxygen barrier layer and the inner layer, the first intermediate layer comprising a polyamide, a second intermediate layer, disposed between the oxygen barrier layer and the outer layer, the second intermediate layer comprising a polyamide, a first tie layer, disposed between the first intermediate layer and the inner layer, the first tie layer comprising an anhydride grafted polymer or copolymer, and a second tie layer, disposed between the second intermediate layer and the outer layer, the second tie layer comprising an anhydride grafted polymer or copolymer, wherein at least one of the inner layer, first tie layer, and first intermediate layer comprises a carbon dioxide scavenger; putting a fresh red meat product into the bag through an open mouth of the bag; drawing a vacuum on the bag to provide a vacuumized bag; heat sealing the open mouth of the bag to provide a hermetic, vacuumized bag; and heat shrinking the hermetic, vacuumized bag around the fresh red meat product.

### BRIEF DESCRIPTION OF THE DRAWINGS

In the drawings presented by way of illustration of the invention:

FIG. 1 illustrates a schematic view of one embodiment of a process for making a multilayer film for use in making a package in accordance with the present invention.

FIG. 2 illustrates a schematic of an end-seal bag for use in making a package in accordance with the present invention, in lay-flat view.

FIG. 3 illustrates a cross-sectional view of the end-seal bag illustrated in FIG. 2, taken through section 13-13 of FIG. 2.

FIG. 4 illustrates a schematic of a side-seal bag for use in making a package in accordance with the present invention, in lay-flat view.

FIG. 5 illustrates a cross-sectional view of the side-seal bag illustrated in FIG. 4, taken through section 15-15 of FIG. 4.

FIG. 6 illustrates a perspective view of a package in accordance with the present invention.

### DETAILED DESCRIPTION OF THE INVENTION

### Definitions

“Bag” herein refers to a bag or a pouch.

“Fresh red meat” herein refers to meat that has not been subjected to a curing or cooking process to alter the characteristics of the meat and includes meat from cattle, sheep, and swine, e.g. beef, lamb, veal, or pork.

“Carbon dioxide scavenger” herein refers to a composition that scavenges, absorbs, or adsorbs carbon dioxide. Suitable carbon dioxide scavengers for use in the present invention include magnesium oxide, calcium oxide, zinc oxide, magnesium hydroxide, and calcium hydroxide.

“Ethylene/alpha-olefin copolymer” (EAO) herein refers to copolymers of ethylene with one or more comonomers selected from C₃ to C₁₀ alpha-olefins such as propene, butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ and ATTANE™ resins supplied by Dow, and ESCORENE™ resins supplied by Exxon; as well as linear homogeneous ethylene/alpha olefin copolymers (HEAO) such as TAFMER™ resins supplied by Mitsui Petrochemical Corporation, EXACT™ and EXCEED™ resins supplied by Exxon, long chain branched (HEAO) AFFINITY™ resins and ELITE™ resins supplied by the Dow Chemical Company, ENGAGE™ resins supplied by DuPont Dow Elastomers, and SURPASS™ resins supplied by Nova Chemicals.

“Ethylene homopolymer or copolymer” herein refers to ethylene homopolymer such as low density polyethylene; ethylene/alpha olefin copolymer such as those defined herein; ethylene/vinyl acetate copolymer; ethylene/alkyl acrylate copolymer; ethylene/(meth)acrylic acid copolymer; or ionomer resin.

“Film” herein means a flexible film, laminate, sheet, web, coating, or the like.

“Olefinic” and the like herein refers to a polymer or copolymer derived at least in part from an olefinic monomer.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, also referred to generally as “copolyamides” herein.

“Polymer” and the like herein means a homopolymer, but also copolymers thereof, including bispolymers, terpolymers, etc.

“Copolymer” herein refers to a polymer formed by the polymerization reaction of at least two different monomers and is inclusive of random copolymers, block copolymers, graft copolymers, etc.

“Solid-state orientation” herein refers to an orientation process carried out at a temperature higher than the highest T_{g} (glass transition temperature) of resins making up the majority of the structure and lower than the highest melting point, of at least some of the film resins, i.e. at a temperature at which at least some of the resins making up the structure are not in the molten state. Solid state orientation may be contrasted to “melt state orientation” i.e. including hot blown films, in which stretching takes place immediately upon emergence of the molten polymer film from the extrusion die.

“Solid state oriented” herein refers to films obtained by either coextrusion or extrusion coating of the resins of the different layers to obtain a primary thick sheet or tube (primary tape) that is quickly cooled to a solid state to stop or slow crystallization of the polymers, thereby providing a solid primary film sheet, and then reheating the solid primary film sheet to the so-called orientation temperature, and thereafter biaxially stretching the reheated film sheet at the orientation temperature using either a tubular solid-state orientation process (for example a trapped bubble method) or using a simultaneous or sequential tenter frame process, and finally rapidly cooling the stretched film to provide a heat shrinkable film. In the trapped bubble solid state orientation process the primary tape is stretched in the transverse direction (TD) by inflation with air pressure to produce a bubble, as well as in the longitudinal direction (LD) by the differential speed between the two sets of nip rolls that contain the bubble. In the tenter frame process the sheet or primary tape is stretched in the longitudinal direction by accelerating the sheet forward, while simultaneously or sequentially stretching in the transverse direction by guiding the heat softened sheet through a diverging geometry frame.

“Heat shrinkable” herein refers to a property of a material which, when heated to a temperature of 200° F., will exhibit a free shrink (ASTM D 2732-83) of at least 8% in the longitudinal direction, and/or at least 8% in the transverse direction. Heat shrinkable films of this invention are solid state oriented as contrasted to hot blown films which are melt state oriented.

“LD” herein refers to the longitudinal direction, i.e. the direction of the film parallel to the path of extrusion. “TD” herein refers to the transverse direction, i.e. the direction of the film transverse to the path of extrusion.

All compositional percentages used herein are presented on a “by weight” basis, unless designated otherwise.

### EXAMPLES

Various inorganic materials, such as metal oxides, hydroxides, and iron are known to react with gaseous carbon dioxide. Monolayer films containing a variety of these carbon dioxide scavengers were prepared at various loading levels and tested. Nanosized materials were used. The films were first tested with calibrated carbon dioxide gases and found to have varying degrees of success in scavenging the headspace gas. Carbon dioxide scavengers were then tested on vacuum packaged meat samples and several were found to successfully reduce or eliminate bubble formation compared with control packages.

The test protocols and results are described herein.

### Pressed Film Preparation

Several samples were prepared. In each case, a potential carbon dioxide scavenger was incorporated into a low density polyethylene (LDPE) resin, PETROTHENE™ NA 345-013 available from Equistar, using a Brabender compounder. Nano-sized materials were chosen where possible in order to have increased particle surface area and provide reduced haze. The Brabender compounder was in each case heated to 180° C. at which point the LDPE resin was added and processed until melted. The selected carbon dioxide scavenger was then added at 10% (4.5 grams scavenger added to 40.5 grams LDPE) or 20% (9.0 grams scavenger added to 36.0 grams LDPE) loading and allowed to blend until well dispersed. The blend was then in each case removed from the compounder. Table 1 lists the carbon dioxide scavengers and the suppliers of these scavengers.

TABLE 1
Material Supplier List

| Carbon | | |
|---|---|---|
| dioxide scavenger | Particle Size | Supplier |
| CaO | ≦40 nm | NanoActive, Cat# 104-1000, |
| (calcium oxide) | | Lot # 04-0002 |
| Ca(OH)₂ | Powder | Baker Lot# E40338 |
| (calcium hydroxide) | | |
| MgO Powder, Plus | ≦4 nm | NanoActive, Plus Cat. # 101-100, |
| (magnesium oxide in | | Lot # 01-0100 |
| powdered form) | | |
| MgO Granular | 10–16 mesh | NanoActive, G, Cat.# 302-0025, |
| (magnesium oxide in | | Lot # 302-0002 |
| granular form) | | |
| ZnO | ≦10 nm | NanoActive, Cat.# 105-0100, |
| (zinc oxide) | | Lot # 05-0102 |
| Molecular Sieve 5 Å, | — | Aldrich Cat. No. 23,367-6 |
| powder¹ | | Lot# 01328mu |
| Molecular Sieve 13X, | ~2μ | Aldrich Cat. No. 28,359-2 |
| powder¹ | | Lot # 04512 |
| HTC | — | LaRoche/UOP |
| (Hydrotalcite) | | Lot # SR00015964 |
| HTC-BS | — | Prepared in-house |
| (Hydrotalcite Bisulfite) | | |

Notes to Table 1:
¹molecular sieves are crystalline metal aluminosilicates with void spaces capable of adsorbing other materials.

Monolayer films of the compounded LDPE batches were then hot pressed on a Carver press to make test samples each having a thickness of approximately 5 mil. The compounded resins and the test film samples were stored in a dry nitrogen glove box until CO₂ scavenging testing was started.

### Test 1—Pressed Film Testing—Dry

The pressed films were in each case cut into 10 cm×10 cm squares, weighed, and placed dry into a P640B™ oxygen barrier pouch available from Cryovac, and having a thickness of about 2.6 mils.

The P640B pouch has the following structure:

| | | |
|---|---|---|
| PVDC-coated | Adhesive | LLDPE |
| Nylon 6 film | | |

Each pouch was vacuum sealed on a Koch packaging machine and then filled with a 25% CO₂/75% N₂ gas mixture. A time zero reading was taken on the Mocon PACCHECK™ O₂/CO₂ dual headspace analyzer and at regular intervals thereafter. The results are shown in Tables 2 and 3. Using the percent CO₂ scavenged at Day 14, the total cc of CO₂ scavenged/gram film and per gram of scavenger were calculated and compared to the theoretical capacity (Table 4). This value would be expected to increase with aging time.

The data in Tables 2 to 4 demonstrates that several of the tested materials scavenged CO₂ from the atmosphere of a package under these dry, room temperature (RT) storage conditions. The calcium and magnesium oxides and hydroxides showed better overall performance under these conditions than the molecular sieves and hydrotalcites, which tend to absorb the gas, rather than react with it. The molecular sieve absorbers are also seen to release some of the gas again with time.

TABLE 2
Change in Percent CO₂ for 10% Additive in Scavenging Films
Dry, Room Temperature (RT) Storage

| Percent and Type of | Film | Percent CO₂ | | | | | |
|---|---|---|---|---|---|---|---|
| CO₂ Scavenger in | Weight | Days | | | | | |
| Film | Grams | 0 | 1 | 4 | 7 | 14 | 28 |
| Control - No CO₂ | 1.72 | 25.40 | 25.6 | 25.2 | 25.1 | 25.2 | 24.0 |
| Scavenger | | | | | | | |
| 10% CaO | 1.95 | 25.40 | 24.20 | 22.80 | 22.40 | 21.30 | 19.7 |
| 10% Ca(OH)₂ | 1.97 | 25.40 | 24.90 | 24.60 | 24.30 | 24.30 | 22.9 |
| 10% MgO | 2.60 | 25.40 | 24.60 | 23.80 | 23.20 | 22.80 | 21.2 |
| 10% ZnO | 1.99 | 25.40 | 25.40 | 25.00 | 24.60 | 24.60 | 23.1 |
| 10% Molecular | 1.70 | 25.40 | 24.20 | 24.30 | 24.80 | 24.80 | 23.5 |
| Sieve 5A | | | | | | | |
| 10% Molecular | 2.05 | 25.40 | 24.10 | 23.90 | 24.10 | 24.40 | 23.0 |
| Sieve 13X | | | | | | | |
| 10% HTC | 2.33 | 25.40 | 25.40 | 25.20 | 24.90 | 24.8 | 22.5 |
| 10% HTC-BS | 2.08 | 25.40 | 25.60 | 25.10 | 24.90 | 24.90 | 23.8 |

TABLE 3
Change in Percent CO₂ for 20% Additive in Scavenging Films
Dry, RT Storage

| Percent and Type of | Film | Percent CO₂ | | | | |
|---|---|---|---|---|---|---|
| CO₂ Scavenger | Weight | Days | | | | |
| in Film | G | 0 | 1 | 4 | 7 | 14 |
| Control - None | 1.72 | 25.40 | 25.6 | 25.2 | 25.1 | 25.2 |
| 20% CaO | 2.02 | 25.40 | 23.10 | 22.10 | 21.10 | 19.00 |
| 20% Ca(OH)₂ | 2.84 | 25.40 | 24.20 | 24.20 | 23.90 | 23.10 |
| 20% MgO | 2.82 | 25.40 | 23.30 | 22.90 | 21.90 | 21.60 |
| 20% ZnO | 2.49 | 25.40 | 25.20 | 25.20 | 24.80 | 24.00 |
| 20% Molecular Sieve 5A | 2.05 | 25.40 | 22.40 | 24.00 | 24.00 | 24.40 |
| 20% Molecular Sieve 13X | 2.10 | 25.40 | 20.40 | 21.60 | 21.90 | 21.90 |
| 20% HTC | 1.94 | 25.40 | 25.20 | 25.90 | 25.30 | 24.50 |
| 20% HTC-BS | 2.58 | 25.40 | 25.00 | 25.70 | 24.90 | 24.40 |

TABLE 4
Comparison of CO₂ Scavenging Capacity of Film
at Day 14 - Dry

| Percent and | | | | | Theoretical |
|---|---|---|---|---|---|
| Type of CO₂ | cc/gram | cc/gram | cc/gram | cc/gram | Scavenging |
| Scavenger in | Film | Film | Scavenger | Scavenger | cc CO2/gram |
| Film | 10% Additive | 20% Additive | 10% Additive | 20% Additive | scavenger. |
| CaO | 4.80 | 8.10 | 47.30 | 40.90 | 399 |
| Ca(OH)₂ | 1.50 | 2.50 | 14.80 | 12.30 | 302 |
| MgO | 2.90 | 3.40 | 29.10 | 17.10 | 556 |
| ZnO | 1.10 | 1.50 | 10.40 | 7.30 | 275 |
| Mol. Sieve 5A | 1.10 | 1.20 | 11.20 | 6.20 | ? |
| Mol. Sieve 13X | 1.40 | 4.20 | 13.80 | 21.20 | ? |
| HTC | 0.70 | 1.00 | 5.80 | 4.90 | ? |
| HTC-BS | 0.60 | 1.00 | 7.00 | 5.20 | ? |

### Test 2—Pressed Film Testing—Moisture

Using the samples containing 20% carbon dioxide scavenger, the pressed films were cut into 10 cm×10 cm squares and each were placed into a P640B™ pouch.

Each pouch contained a small absorbent pad with 2 milliliters of water added to supply moisture to the pouch interior. The samples were vacuum sealed on a Koch packaging machine to remove headspace gases and then filled with a 25% CO₂/75% N₂ gas mixture. A time zero reading was taken on a Mocon PACCHECK™ O₂/CO₂ dual headspace analyzer and at regular intervals thereafter. The data is reported in Tables 5 and 6.

TABLE 5
Change in Percent CO₂ for 20% Additive in Scavenging Films
Moist, RT Storage

| | | Percent CO₂ | | | | |
|---|---|---|---|---|---|---|
| | Weight | Days | | | | |
| Sample | g | 0 | 1 | 3 | 7 | 14 |
| 20% CaO | 2.6021 | 25.20 | 18.60 | 4.20 | 0.70 | 0.30 |
| 20% Ca(OH)₂ | 2.0016 | 25.20 | 21.40 | 6.40 | 3.00 | 0.60 |
| 20% MgO | 2.4809 | 25.20 | 22.70 | 16.50 | 12.30 | 5.60 |
| 20% ZnO | 2.2242 | 25.20 | 23.70 | 21.60 | 21.10 | 18.90 |
| 20% Mol. Sieve 5A | 2.2493 | 25.20 | 23.50 | 24.00 | 23.50 | 22.80 |
| 20% Mol. Sieve 13X | 1.7777 | 25.20 | 23.90 | 24.90 | 24.70 | 23.90 |
| 20% HTC | 2.2105 | 25.20 | 25.50 | 25.00 | 24.80 | 24.10 |

TABLE 6
Comparison of Scavenging Capacity of Film
at Day 14 - Moist

| | cc/g | Cc/g | Theoretical |
|---|---|---|---|
| | Film | Scavenger | Scavenging |
| Sample | 20% Additive | 20% Additive | cc CO2/g scavenger |
| CaO | 24.52 | 122.60 | 399 |
| Ca(OH)₂ | 28.04 | 140.20 | 302 |
| MgO | 18.76 | 93.80 | 556 |
| ZnO | 7.50 | 37.50 | 275 |
| Mol. Sieve 5A | 2.94 | 14.70 | ? |
| Mol. Sieve 13X | 1.45 | 7.25 | ? |
| HTC | 1.33 | 6.65 | ? |

The data in Tables 5 and 6 demonstrates that the addition of moisture resulted in an increase, by more than 3 to 5 times, the scavenging effect of several of the films compared with the respective dry samples of the films. The calcium and magnesium oxides and hydroxides showed better overall performance under these moist conditions than the molecular sieves and hydrotalcite.

### Test 3—Meat Packaging Test Samples

### Film Preparation

Masterbatches of some of the carbon dioxide scavengers from the previous tests were prepared on a LEISTRITZ™ twin screw extruder in the low density polyethylene (LDPE) carrier resin, PETROTHENE™ NA 345-013. Using these materials, 2 mil monolayer films of 90% LDPE and 10% additive were prepared on the Leistritz twin screw extruder. A K-tron volumetric feeder #4 was run at 120 rpm and a 6″ flat die was used. The conditions used were as described in Table 7.

The rolls of the five prepared films were kept stored in a dry nitrogen purged glove box until tested for carbon dioxide scavenging.

TABLE 7
Extrusion Conditions for Monolayer Film Preparation
10% Additive

| | Extruder Zones | | | | | | | | | | | |
|---|---|---|---|---|---|---|---|---|---|---|---|---|
| | ° C. | | | | | | | | | | | |
| Scavenger | 1 | 2 | 3 | 4 | 5 | 6 | 7 | 8 | Die | Torque % | RPM | psi |
| CaO | 190 | 190 | 190 | 190 | 200 | 200 | 205 | 205 | 205 | 45–50 | 100 | 200–250 |
| ZnO | 190 | 190 | 190 | 190 | 200 | 200 | 205 | 205 | 205 | 45–55 | 100 | 240–270 |
| Granular | 190 | 190 | 190 | 190 | 200 | 200 | 205 | 205 | 205 | 50 | 100 | 210–230 |
| MgO | | | | | | | | | | | | |
| MgO Powder | 190 | 190 | 190 | 190 | 200 | 200 | 205 | 205 | 205 | 50–60 | 100 | 200–240 |

### Optical Measurements on Prepared Films

The film samples were tested for optical properties. As can be seen in the data in Table 8, the choice of nano-particle carbon dioxide scavenger had a measurable effect on the optical properties of the prepared films. This data shows the MgO sample had the lowest haze values for the tested oxide materials, with all of the nano materials compounded at 10% loading levels. It would be beneficial to balance the scavenging performance of a given carbon dioxide scavenger with particle size, induced haze and cost.

TABLE 8
Optical Measurements on Monolayer Film Samples

| | | Transmittance | | Film Thickness |
|---|---|---|---|---|
| Sample | Haze (%) | (%) | Clarity (%) | (mil) |
| 10% MgO | 59.3 ± 0.3 | 93.9 ± 0.1 | 0.0 | 2.58 ± 0.04 |
| powder | | | | |
| 10% CaO | 64.1 ± 0.4 | 93.7 ± 0.1 | 0.0 | 1.89 ± 0.04 |
| 10% ZnO | 78.4 ± 0.7 | 90.6 ± 0.1 | 0.0 | 2.21 ± 0.03 |

### CO₂ Scavenging Performance for 2 mil, Monolayer Extruded Films

Each sample film was tested in triplicate. A 10 cm×10 cm film was cut from the center width of the film roll and each was placed into a P640B™ barrier pouch. Each pouch was vacuum sealed on a Koch packaging machine. Each bag was inflated with 300 cc of a 25% CO₂/75% N₂ gas mixture and then injected with 2 ml of de-ionized water to facilitate the scavenging. A time zero reading was taken on a Mocon PAC CHECK™ O₂/CO₂ dual headspace analyzer and at regular intervals thereafter. A set of samples were stored at room temperature (RT), and a second set in a refrigerator. The average data is reported in Table 9 for RT storage samples. The average data for refrigerated samples are reported in Table 10.

As can be seen by the data in Tables 9 and 10, the refrigerated samples scavenged more slowly than the room temperature samples.

TABLE 9
CO₂ Scavenging Films, 10% Additive
Moist with Room Temperature (RT) Storage

| | Percent CO₂ | | | | | | |
|---|---|---|---|---|---|---|---|
| | Days | | | | | | |
| Scavenger | 0 | 1 | 4 | 7 | 14 | 21 | 28 |
| CaO | 24.87 | 22.40 | 21.63 | 21.47 | 20.10 | 19.07 | 18.30 |
| ZnO | 25.07 | 23.50 | 23.40 | 22.60 | 21.37 | 19.30 | 18.13 |
| MgO Granular | 25.10 | 22.77 | 21.43 | 20.30 | 18.70 | 16.53 | 15.10 |
| MgO Powder | 24.87 | 22.43 | 20.23 | 19.13 | 17.07 | 14.73 | 13.37 |

TABLE 10
CO₂ Scavenging Films, 10% Additive
Moist with Refrigerated Storage

| | Percent CO₂ | | | | | |
|---|---|---|---|---|---|---|
| | Days | | | | | |
| Scavenger | 0 | 1 | 4 | 7 | 21 | 28 |
| CaO | 24.67 | 23.53 | 23.20 | 22.57 | 20.40 | 19.47 |
| ZnO | 24.73 | 24.17 | 23.67 | 23.63 | 23.33 | 23.33 |
| MgO Granular | 24.77 | 23.43 | 22.70 | 22.40 | 21.70 | 21.13 |
| MgO Powder | 24.77 | 23.73 | 22.73 | 22.50 | 21.20 | 20.83 |

### Meat Packaging Tests

Samples of the prepared monolayer extruded LDPE films containing 10% of the carbon dioxide scavengers were in each case placed on top of a meat sample (pork), and vacuum packaged in the P640B™ packaging material. The packaged meats were allowed to age in a refrigerator. After 45 days the control packages had noticeable bubble formation and appeared to have completely lost vacuum. The samples with the CO₂ scavengers still showed a tight package appearance with few bubbles. The packages were analyzed for gas bubble composition.

### GC Analysis

The headspace gases from the vacuum packaged pork packages were analyzed for CO₂ content via gas chromatograph (GC). For each injection, a 1 mL sample of the headspace was removed from each package and injected into the GC using the instrumental conditions given in Table 11.

TABLE 11
GC Conditions for Analysis of CO₂

| | |
|---|---|
| Instrument: | HP 5890 ™ A GC with thermal conductivity |
| | detector (TCD) |
| Carrier: | Helium @ 47 mL/min |
| Column: | ALLTECH ™ CTR-1, 6 ft. |
| Temperature Program: | 35° C. isothermal for 8 minutes |
| Injector Temperature: | 35° C. |
| Detector Temperature: | 50° C. |
| Sample Size: | 1 mL |

Calibration of the GC-TCD was achieved with a I % CO₂ standard gas. A sample of the laboratory air was injected as a reference. The air contained 78.08% N₂, 20.95% O₂ and 0.033% CO₂ The measured CO₂ concentrations in the pork packages are detailed in Table 12.

An analysis of the data in Table 12 shows that the bubbles formed in the control samples were carbon dioxide. No adverse color changes were noted on the meat surface. The addition of the CO₂ scavengers, even at only 10% loading had a measurable effect on the concentration of carbon dioxide in the aged vacuum package and resulted in no or less carbon dioxide bubble formation and an overall improved appearance, compared with the control samples.

TABLE 12
CO₂ Analysis in Aged Vacuum Packaged Pork Packages

| Sample # | Pouch Identification | CO₂ (%) |
|---|---|---|
| 1 | 10% Powder MgO - A | 17* |
| 2 | 10% Powder MgO - B | 60 |
| 3 | 10% Powder MgO - C | 43 |
| 4 | 10% Granular MgO - A | ND |
| 5 | 10% Granular MgO - B | ND |
| 9 | 10% Granular MgO - C | ND |
| 6 | 10% CaO - A | 0.4 |
| 7 | 10% CaO - B | 0.1 |
| 8 | 10% CaO - C | 0.1 |
| 10 | Control - A | 97 |
| 11 | Control - B | 98 |
| 12 | Control - C | 98 |

ND = none detected
*= Suspected Leaker Based on the O₂ [level.

Film Embodiments of the Invention

A representative film structure #1 in accordance with the invention, formed into a bag, is as follows:

| | | Intermediate | |
|---|---|---|---|
| | Oxygen | Layer | PO |
| PO | barrier | (+CS) | (+CS) |
| A | D | F | G |

The polyolefin of layers A and G, i.e. the outer layer and inner layer respectively, can comprise any suitable polyolefin, e.g. an ethylene alpha olefin copolymer, or any blends thereof. Suitable additives can also be included in either or both layers. Such additives can include, but are not necessarily limited to, fillers, pigments, dyestuffs, antioxidants, antiblock agents, slip agents, stabilizers, processing aids, plasticizers, fire retardants, etc.

Oxygen barrier materials in accordance with the invention have an oxygen permeability, of the barrier material, less than 500 cm³ O₂/m²·day·atmosphere (tested at 1 mil thick and at 25° C. according to ASTM D3985), such as less than 100, less than 50, less than 25, less than 10, less than 5, and less than 1 cm³ O₂/m²·day·atmosphere. Examples of polymeric materials with low oxygen transmission rates are ethylene/vinyl alcohol copolymer (EVOH), polyvinylidene dichloride (PVDC), vinylidene chloride/methyl acrylate copolymer, polyamide, and polyester.

The intermediate layer can comprise any suitable polymer or copolymer, including e.g. olefin polymer or copolymer, polyamide or copolyamide (e.g. nylon 6) or anhydride grafted polymer or copolymer.

Additional polymeric layers can be incorporated into the film structure as desired to achieve a functionality, e.g. a bulk layer, adhesive layer, oxygen scavenging layer, sealant layer, layer to add a higher modulus material, etc., either between two given layers or on either side of the film structure.

In another embodiment, a representative film structure #2 in accordance with the invention, formed into a bag, is as follows:

| | | | | Nylon | Tie | PO |
|---|---|---|---|---|---|---|
| PO | Tie | nylon | EVOH | (+ CS) | (+ CS) | (+ CS) |
| A | B | C | D | E | F | G |

The polyolefin of layers A and G, i.e. the outer layer and inner layer respectively, can each comprise any suitable polyolefin as described above.

The EVOH of the oxygen barrier layer can have any suitable mole % of ethylene, e.g. from 28 to 40 mole % ethylene.

Nylon layers E and C, representing first and second intermediate layers respectively, can each comprise any suitable polyamide or copolyamide.

Tie layers F and B can each comprise any suitable polymeric adhesive layer, such as an olefin polymer or copolymer having an anhydride functionality grafted thereon and/or copolymerized therewith and/or blended therewith. Examples are anhydride grafted ethylene/1-butene copolymer, anhydride grafted ethylene/1-hexene copolymer, anhydride grafted ethylene/1-octene copolymer, anhydride grafted polypropylene, anhydride grafted high density polyethylene, anhydride grafted polyamide, and anhydride grafted ethylene/vinyl acetate copolymer.

In yet another embodiment, a representative film structure #3 in accordance with the invention is as follows:

| | | | | Amorphous | | |
|---|---|---|---|---|---|---|
| | | Amorphous | | nylon + semicrystalline | | |
| | | nylon + Semicrystalline | | nylon | Tie | PO |
| PO | Tie | nylon | EVOH | (+CS) | (+CS) | (+CS) |
| A | B | C | D | E | F | G |

The polyolefin of layers A and G, i.e. the outer layer and inner layer respectively, can each comprise any suitable polyolefin as described above.

The tie layers F and B can each comprise any suitable material as described above for film structure #2.

Nylon layers E and C, representing first and second intermediary layers respectively, can each comprise any suitable polyamide or copolyamide provided each layer comprises a blend of amorphous and semicrystalline nylon. These two nylon types can be present in the respective layer in any appropriate proportions.

In each of the representative film structures #1, #2, and #3, “A”, “B”, etc. each represent a distinct film layer, and a carbon dioxide scavenger (“CS”) is disposed in any one of, any combination of, or all of, layers “F”, and “G” (Film structure #1) or layers “E”, “F”, and “G” (Film structures #2 and #3), where layer “G” is an outer film layer that when formed into a bag, is the layer in contact with the interior of the bag and/or the food product contained in the bag, and will typically be the inner/sealant layer.

The carbon dioxide scavenger can be present in a given layer in any suitable amount e.g. from 0.1% to 30%, by weight of the layer in which the carbon dioxide scavenger is present, such as from 1% to 25%, from 5% to 20%, and from 10% to 15%, by weight of the layer in which the carbon dioxide scavenger is present.

Several multilayer film structures were made in accordance with the invention. These, and comparatives, are identified below. Multilayer films of the invention can be made using conventional extrusion, coextrusion, and/or lamination processes. Likewise, conventional manufacturing processes can be used to make a bag from the film. Resins are identified in Table 13.

TABLE 13
Resin Identification

| Material | Tradename Or | |
|---|---|---|
| Code | Designation | Source(s) |
| AD1 | BYNEL ™ 39E660 | DuPont |
| AD2 | PX3236 ™ | Equistar |
| IO1 | SURLYN ™ 1650SB | DuPont |
| OB1 | SOARNOL ™ ET3803 | Nippon Gohsei |
| PA1 | ULTRAMID ™ B33LN 01 | BASF |
| PA2 | AEGIS ™ H100WP | Honeywell |
| PA3 | GRIVORY ™ G21 | EMS |
| EV1 | ELVAX ™ 3175 | DuPont |
| PB1 | PB8640M ™ | Basell |
| PE1 | EXACT ™ 3024 | ExxonMobil |
| SL1 | 1080864S ™ | Clariant |
| SL2 | GRILON ™ MB 3361 FS NATURAL | EMS |
| SL3 | FSU ™ 255E | Schulman |
| CS1 | ELASTOMAG ™ 170 Special MgO | Akrochem |
| CSM1 | — | — |
| CSM2 | — | — |

AD1 is a maleic anhydride-modified ethylene/vinyl acetate copolymer with a vinyl acetate content of 11.8% by weight of the copolymer.

AD2 is a maleic anhydride-modified linear low density polyethylene.

IO1 is an ionomer resin, being a zinc neutralized ethylene/methacrylic acid copolymer with a slip agent.

OB1 is an ethylene/vinyl alcohol copolymer with between 30 mole % and 40 mole % ethylene.

PA1 is a nylon 6 (poly(caprolactam)).

PA2 is a nylon 6 (poly(caprolactam)).

PA3 is an amorphous nylon, i.e. a poly(hexamethylene diamine/isophthalic acid/terephthalic acid).

EV1 is an ethylene/vinyl acetate copolymer having more than 20%, by weight of the copolymer, of vinyl acetate comonomer.

PB1 is a polybutylene.

PE1 is a single site catalyzed ethylene/1-butene copolymer having a density of 0.905 grams per cubic centimeter.

SL1 is a masterbatch having about 70% nylon 6, 20% silica and 10% erucamide.

SL2 is a masterbatch having nylon, an antiblock agent such as silica, and a slip agent such as wax.

SL3 is a masterbatch having about 70% low density polyethylene with 25% silica and 5% erucamide.

CS1 is a magnesium oxide in powdered form, having a surface area of 165 m²/gram, and a bulk density of 24 lb/ft³, with an average particle size of less than 2.5 microns for 88% of particles.

CSM1 is a masterbatch having 75%, by weight of the masterbatch, of PE1, and 25%, by weight of the masterbatch, of CS1.

CSM2 is a masterbatch having 60%, by weight of the masterbatch, of PE1, 25%, by weight of the masterbatch, of CS1, and 15%, by weight of the masterbatch, of stearic acid.

All compositional percentages given herein are by weight, unless indicated otherwise.

Four multilayer films were produced by an otherwise conventional coextrusion process. These films each had a final thickness of about 7 mils. These film examples are:

Example 1 with 2.5%, by weight of the sealing layer, magnesium oxide (with no stearic acid) present in the sealing layer,

Example 2 with 1.25%, by weight of the sealing layer, magnesium oxide (with no stearic acid) present in the sealing layer,

Example 3 with 2.5%, by weight of the sealing layer, magnesium oxide, and 1.5%, by weight of the sealing layer, stearic acid present in the sealing layer, and

Example 4 with 1.25%, by weight of the sealing layer, magnesium oxide, and 0.75%, by weight of the sealing layer, stearic acid present in the sealing layer.

“Gauge” in Table 14 refers to actual gauge (in mils) for Examples 1, 2, and 4, and to target gauge for Example 3.

TABLE 14

| | | | | | | | | inside/ |
|---|---|---|---|---|---|---|---|---|
| | Outside | | | | | | | sealant side |
| | Layer 1 | Layer 2 | Layer 3 | Layer 4 | Layer 5 | Layer 6 | Layer 7 | Layer 8 |
| Example 1 | 96% PA1 & | AD1 | 80% PA2 & | OB1 | 80% PA2 & | AD2 | 58% IO1 & | 84% PE1 & |
| | 2% SL1 & | | 20% PA3 | | 20% PA3 | | 22% EV1 & | 6% SL3 & |
| | 2% SL2 | | | | | | 20% PB1 | 10% CSM1 |
| gauge | 0.91 | 1.85 | 0.55 | 0.76 | 0.55 | 0.52 | 1.00 | 0.43 |
| Example 2 | 96% PA1 & | AD1 | 80% PA2 & | OB1 | 80% PA2 & | AD2 | 58% IO1 & | 89% PE1 & |
| | 2% SL1 & | | 20% PA3 | | 20% PA3 | | 22% EV1 & | 6% SL3 & |
| | 2% SL2 | | | | | | 20% PB1 | 5% CSM1 |
| gauge | 0.97 | 2.22 | 0.61 | 0.80 | 0.61 | 0.52 | 0.97 | 0.44 |
| Example 3 | 96% PA1 & | AD1 | 80% PA2 & | OB1 | 80% PA2 & | AD2 | 58% IO1 & | 84% PE1 & |
| | 2% SL1 & | | 20% PA3 | | 20% PA3 | | 22% EV1 & | 6% SL3 & |
| | 2% SL2 | | | | | | 20% PB1 | 10% CSM2 |
| gauge | 0.91 | 2.31 | 0.56 | 0.70 | 0.56 | 0.56 | 1.05 | 0.35 |
| Example 4 | 96% PA1 & | AD1 | 80% PA2 & | OB1 | 80% PA2 & | AD2 | 58% IO1 & | 89% PE1 & |
| | 2% SL1 & | | 20% PA3 | | 20% PA3 | | 22% EV1 & | 6% SL3 & |
| | 2% SL2 | | | | | | 20% PB1 | 5% CSM2 |
| gauge | 0.72 | 2.29 | 0.64 | 0.89 | 0.63 | 0.53 | 0.98 | 0.45 |

### Analytical Evaluations

The haze (ASTM D 1003) and clarity (ASTM D 1746) of Examples 1 to 4 were determined and the results are shown in Table 15.

TABLE 15
Summary of Optical Properties

| Example | % MgO in sealant layer | Haze | Clarity |
|---|---|---|---|
| Control Film 1* | 0 | 8.2 | NA |
| Example 1 | 2.5 | 12.9 | 1.9 |
| Example 2 | 1.25 | 10.0 | 2.4 |
| Example 3 | 2.5 & 1.5% stearic acid | 18.2 | 1.0 |
| Example 4 | 1.25 & 0.75% stearic acid | 11.6 | 1.6 |

The carbon dioxide scavenging functionality of the films was tested. The results are shown in Table 16.

TABLE 16
CO2 Scavenging Test Results

| | Percent CO₂ | | | | |
|---|---|---|---|---|---|
| | Days | | | | |
| Example | 0 | 1 | 4 | 7 | 14 |
| Example 1 A | 23 | 23 | 22.2 | 22.2 | 21.2 |
| Example 1 B | 23.3 | 23.2 | 22.2 | 21.6 | 21.1 |
| Example 1 C | 23.6 | 23.3 | 22.5 | 22 | 21.4 |
| Example 1 Average | 23.3 | 23.16 | 22.3 | 21.93 | 21.23 |
| Example 1 % Decrease | 0 | 0.57 | 4.29 | 5.86 | 8.87 |
| Example 2A | 23.6 | 23.4 | 22.6 | 22.3 | 21.5 |
| Example 2B | 24 | 23.3 | 22.7 | 22.3 | 21.2 |
| Example 2C | 23.6 | 23.7 | 22.4 | 22.1 | 22 |
| Example 2 Average | 23.73 | 23.46 | 22.56 | 22.23 | 21.56 |
| Example 2 % Decrease | 0 | 1.12 | 4.91 | 6.32 | 9.13 |
| Example 3A | 23.5 | 23.6 | 22 | 21.9 | 21 |
| Example 3B | 23.9 | 23.3 | 23.2 | 22.2 | 21.6 |
| Example 3C | 23.4 | 23.3 | 22.9 | 22.3 | 21.4 |
| Example 3 Average | 23.6 | 23.4 | 22.7 | 22.13 | 21.33 |
| Example 3 % Decrease | 0 | 0.85 | 3.81 | 6.21 | 9.60 |
| Example 4A | 23.5 | 23.2 | 22.9 | 22.3 | 21.4 |
| Example 4B | 23.6 | 23.6 | 21.9 | 21.9 | 21.3 |
| Example 4C | 23.9 | 23.3 | 22.7 | 22.2 | 21.6 |
| Example 4 Average | 23.67 | 23.37 | 22.5 | 22.13 | 21.43 |
| Example 4 % Decrease | 0 | 1.27 | 4.93 | 6.48 | 9.44 |
| Control Film 1* A | 23.6 | 23.3 | 22.8 | 22.3 | 21.4 |
| Control Film 1* B | 24 | 24.1 | 23.3 | 22.3 | 21.9 |
| Control Film 1* C | 24.1 | 24.1 | 23 | 22.5 | 22 |
| Control Film 1 Average | 23.9 | 23.83 | 23.03 | 22.37 | 21.77 |
| Control Film 1 % Decrease | 0 | 0.28 | 3.63 | 6.42 | 8.93 |

*The Control Film 1 was like the film of Examples 1 to 4, but contained no added magnesium oxide, and had an inside/sealant side layer 8 that comprised 94% PE1 and 6% SL3.

Four additional multilayer films were produced by an otherwise conventional coextrusion process. These films each had a final thickness of about 7 mils. These film examples are:

Example 5 with 5%, by weight of the sealing layer, magnesium oxide (with no stearic acid) present in the sealing layer,

Example 6 with 10%, by weight of the sealing layer, magnesium oxide present in the sealing layer,

Example 7 with 15%, by weight of the sealing layer, magnesium oxide present in the sealing layer, and

Example 8 with 23.5%, by weight of the sealing layer, magnesium oxide present in the sealing layer.

“Gauge” in Table 17 refers to target gauge (in mils) for Examples 5 to 8.

TABLE 17

| | | | | | | | | inside/ |
|---|---|---|---|---|---|---|---|---|
| | Outside | | | | | | | sealant side |
| | Layer 1 | Layer 2 | Layer 3 | Layer 4 | Layer 5 | Layer 6 | Layer 7 | Layer 8 |
| Example 5 | 96% PA1 & | AD1 | 80% PA2 & | OB1 | 80% PA2 & | AD2 | 58% IO1 & | 74% PE1 & |
| | 2% SL1 & | | 20% PA3 | | 20% PA3 | | 22% EV1 & | 6% SL3 & |
| | 2% SL2 | | | | | | 20% PB1 | 20% CSM1 |
| Gauge | 0.91 | 2.31 | 0.56 | 0.70 | 0.56 | 0.56 | 1.05 | 0.35 |
| Example 6 | 96% PA1 & | AD1 | 80% PA2 & | OB1 | 80% PA2 & | AD2 | 58% IO1 & | 54% PE1 & |
| | 2% SL1 & | | 20% PA3 | | 20% PA3 | | 22% EV1 & | 6% SL3 & |
| | 2% SL2 | | | | | | 20% PB1 | 40% CSM1 |
| Gauge | 0.91 | 2.31 | 0.56 | 0.70 | 0.56 | 0.56 | 1.05 | 0.35 |
| Example 7 | 96% PA1 & | AD1 | 80% PA2 & | OB1 | 80% PA2 & | AD2 | 58% IO1 & | 34% PE1 & |
| | 2% SL1 & | | 20% PA3 | | 20% PA3 | | 22% EV1 & | 6% SL3 & |
| | 2% SL2 | | | | | | 20% PB1 | 60% CSM1 |
| Gauge | 0.91 | 2.31 | 0.56 | 0.70 | 0.56 | 0.56 | 1.05 | 0.35 |
| Example 8 | 96% PA1 & | AD1 | 80% PA2 & | OB1 | 80% PA2 & | AD2 | 58% IO1 & | 6% SL3 & |
| | 2% SL1 & | | 20% PA3 | | 20% PA3 | | 22% EV1 & | 94% CSM1 |
| | 2% SL2 | | | | | | 20% PB1 | |
| Gauge | 0.91 | 2.31 | 0.56 | 0.70 | 0.56 | 0.56 | 1.05 | 0.35 |

### CO₂ Scavenging Test Results

The prepared films, and some previously prepared materials, were cut into 10 cm×20 cm pieces, placed in foil bags, vacuum sealed and then injected with 500 cc of a 25% CO₂/75% N₂ calibrated gas mixture and 10 cc deionized water. The percent CO₂ was measured in the bags periodically. The data is given in Table 18 below.

TABLE 18
CO₂ Scavenging

| | Percent CO₂ | | | |
|---|---|---|---|---|
| | Days | | | |
| Examples | 0 | 1 | 7 | 14 |
| Control - Foil Bag | 23.90 | 23.13 | 23.33 | 23.53 |
| Example 2 (1.25% MgO) | 23.77 | 23.20 | 23.03 | 23.33 |
| Example 1 (2.5% MgO) | 23.83 | 23.13 | 23.50 | 23.20 |
| Example 5 (5% MgO) | 24.10 | 23.10 | 22.80 | 22.43 |
| Example 6 (10% MgO) | 23.80 | 22.60 | 21.87 | 21.63 |
| Example 7 (15% MgO) | 23.67 | 22.40 | 21.33 | 21.20 |
| Example 8 (25% MgO) | 24.07 | 20.77 | 19.27 | 18.47 |

It can be seen by the data in Table 18, that some CO₂ was removed from the package headspace by the films of the invention. However, the results of Table 18 were not as beneficial as expected. It is believed that the excessively high level (500 cc) of the 25% CO₂/75% N₂ gas mixture injected into each foil bag overwhelmed the carbon dioxide scavenging capacity of the carbon dioxide scavenger. This was therefore considered to be an inappropriate test for the efficacy of the carbon dioxide scavengers in films of the invention.

The above test was repeated, but with 100 cc instead of 500 cc of a 25% CO₂/75% N₂ calibrated gas mixture and 10 cc deionized water. The percent CO₂ was measured in the bags periodically using a Mocon PACCHECK™ headspace gas analyzer with an 8 cc autosampler. The data is given in Table 19 below.

TABLE 19
CO₂ Scavenging

| Examples | 0 | 1 | 4 | 7 | 14 |
|---|---|---|---|---|---|
| Control - Foil Bag | 22.30 | 21.70 | 21.03 | 20.53 | 20.93 |
| Example 2 (1.25% MgO) | 22.50 | 21.37 | 20.90 | 20.20 | 20.10 |
| Example 4 (1.25% MgO) | 22.40 | 21.07 | 19.97 | 20.30 | 20.03 |
| Example 1 (2.5% MgO) | 22.63 | 21.20 | 20.50 | 19.50 | 19.30 |
| Example 3 (2.5% MgO) | 22.53 | 21.47 | 20.70 | 20.30 | 20.30 |
| Example 5 (5% MgO) | 23.13 | 20.60 | 18.73 | 18.23 | 17.20 |
| Example 6 (10% MgO) | 22.93 | 19.33 | 15.73 | 14.07 | 12.90 |
| Example 7 (15% MgO) | 22.60 | 15.83 | 11.33 | 8.97 | 6.27 |
| Example 8 (23.5% MgO) | 22.67 | 11.53 | 0.70 | 0.03 | 0.00 |

TABLE 20

| | | | | Percent of |
|---|---|---|---|---|
| | Total CO₂ | Avg. grams | Scavenging/ | Theoretical |
| | scavenged | Scavenger | gram | Capacity |
| | by Sample | in Sample | in 14 Days | Scavenged |
| Examples | cc CO₂ | g | cc CO₂/g | % |
| Example 2 | 0.60 | 0.0022 | 274.29 | 49.33 |
| Example 1 | 1.29 | 0.0044 | 294.86 | 53.03 |
| Example 5 | 3.83 | 0.0088 | 437.71 | 78.73 |
| Example 6 | 7.57 | 0.0175 | 432.57 | 77.80 |
| Example 7 | 13.32 | 0.0263 | 507.43 | 91.26 |
| Example 8 | 20.06 | 0.0412 | 486.89* | 100.00* |

*Example 8 scavenged all of the headspace CO₂ in the bag within 7 days.

It can be seen by the data in Table 19, that CO₂ can be removed from the package headspace by the films. It can be calculated that 1 gram of MgO has the ability to react with a maximum of 556 cc of CO₂ at standard temperature and pressure. It can be seen by the data in Table 20 that several of the film samples, Examples 5 to 8, approached this theoretical scavenging capacity during the 14 days of testing. Example 20 scavenged all of the headspace CO₂ in the bag within 7 days.

Bag Production

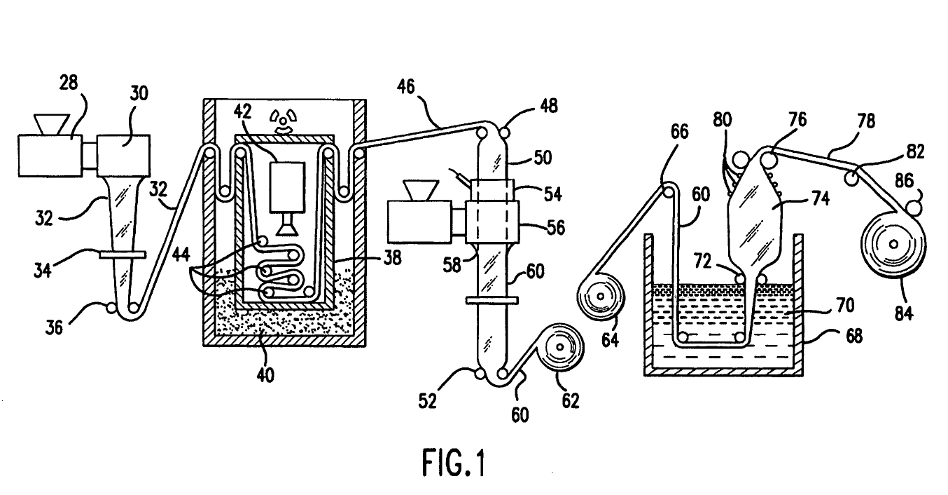

In one embodiment of the process illustrated in FIG. 1, solid polymer beads (not illustrated) are fed to a plurality of extruders 28 (for simplicity, only one extruder is illustrated). Inside extruders 28, the polymer beads are forwarded, melted, and degassed, following which the resulting bubble-free melt is forwarded into die head 30, and extruded through an annular die, resulting in tubing 32 which is in one embodiment from about 10 mils to 40 mils thick, e.g. about 20 to 30 mils thick.

After cooling or quenching by water spray from cooling ring 34, tubing 32 is collapsed by pinch rolls 36, and is thereafter fed through irradiation vault 38 surrounded by shielding 40, where tubing 32 is irradiated with high energy electrons (i.e., ionizing radiation) from iron core transformer accelerator 42. Tubing 32 is guided through irradiation vault 38 on rolls 44. Tubing 32 is in one embodiment irradiated to a level of from 30 to 80 kiloGrays, e.g. 40 to 70, or 50 to 60 kiloGrays.

After irradiation, irradiated tubing 46 is directed through pinch rolls 48, following which irradiated tubing 46 is slightly inflated, resulting in trapped bubble 50. However, at trapped bubble 50, the tubing is not significantly drawn longitudinally, as the surface speed of nip rolls 52 are about the same speed as nip rolls 48. Furthermore, irradiated tubing 46 is inflated only enough to provide a substantially circular tubing without significant transverse orientation, i.e., without stretching.

Slightly inflated, irradiated tubing 50 is passed through vacuum chamber 54, and thereafter forwarded through coating die 56. Second tubular film 58 is melt extruded from coating die 56 and coated onto slightly inflated, irradiated tube 50, to form two-ply tubular film 60. Second tubular film 58 preferably comprises an O₂ barrier layer, which does not pass through the ionizing radiation. Further details of the above-described coating step are generally as set forth in U.S. Pat. No. 4,278,738, to Brax et. al., which is hereby incorporated by reference thereto, in its entirety.

After irradiation and coating, two-ply tubing film 60 is wound up onto windup roll 62. Thereafter, windup roll 62 is removed and installed as unwind roll 64, on a second stage in the process of making the tubing film as ultimately desired. Two-ply tubular film 60, from unwind roll 64, is unwound and passed over guide roll 66, after which two-ply tubular film 60 passes into hot water bath tank 68 containing hot water 70. The now collapsed, irradiated, coated tubular film 60 is submersed in hot water 70 (having a temperature of about 185.degree. F.) for a retention time of at least about 30 seconds, i.e., for a time period in order to bring the film up to the desired temperature for biaxial orientation. Thereafter, irradiated tubular film 60 is directed through nip rolls 72, and bubble 74 is blown, thereby transversely stretching tubular film 60. Furthermore, while being blown, i.e., transversely stretched, nip rolls 76 draw tubular film 60 in the longitudinal direction, as nip rolls 76 have a surface speed higher than the surface speed of nip rolls 72. As a result of the transverse stretching and longitudinal drawing, irradiated, coated biaxially solid state oriented blown tubing film 78 is produced, this blown tubing having been both transversely stretched in a ratio of from about 1:1.5 to 1:6, and drawn longitudinally in a ratio of from about 1:1.5 to 1:6. For example, the stretching and drawing are each performed a ratio of from about 1:2 to 1:4. The result is a biaxial orientation of from about 1:2.25 to 1:36, such as 1:4 to 1:16. While bubble 74 is maintained between pinch rolls 72 and 76, blown tubing 78 is collapsed by rolls 80, and thereafter conveyed through pinch rolls 76 and across guide roll 82, and then rolled onto wind-up roll 84. Idler roll 86 assures a good wind-up.

In an alternative embodiment, the process described in FIG. 1 can be modified by making a fully coextruded film, such as a fully coextruded tubular film, that does not require an extrusion coating step. Thus, the irradiated tubing 46 can thus be collected onto wind-up roll 62, without the intervening extrusion coating step shown in FIG. 1. The wound-up tubing can be immediately, or at some point thereafter, be advanced to the solid-state orientation process shown in the right side of FIG. 1, i.e. from reference numeral 64 forward,

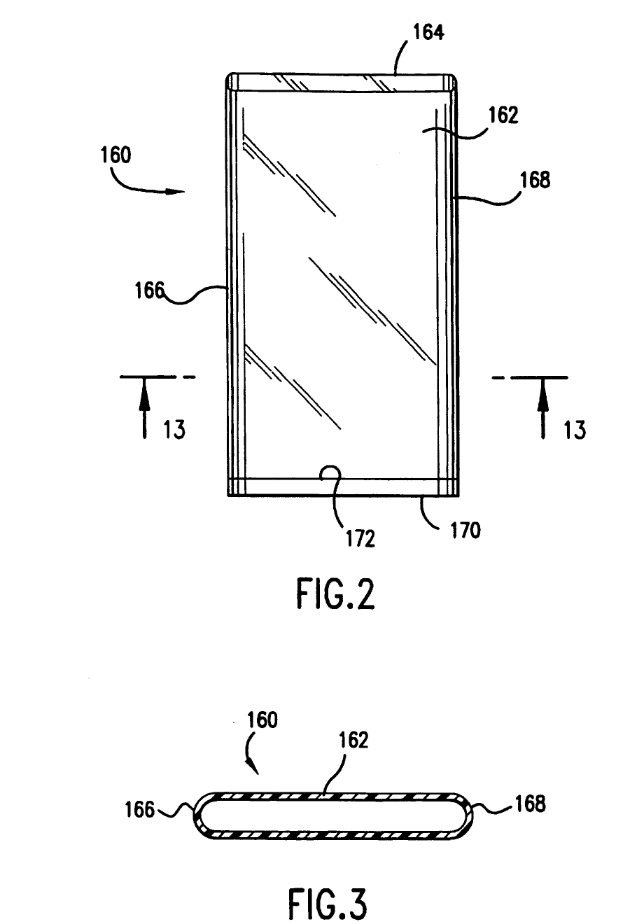

FIG. 2 is a schematic of an end seal bag 160, in a lay-flat position, this bag being in accord with one embodiment of the present invention; FIG. 3 is a cross-sectional view of bag 160 taken through section 13-13 of FIG. 2. Viewing FIGS. 2 and 3 together, bag 160 comprises bag film 162, top edge 164 defining an open bag mouth, first bag side edge 166, second bag side edge 168, bottom edge 170, and end (bottom) seal 172.

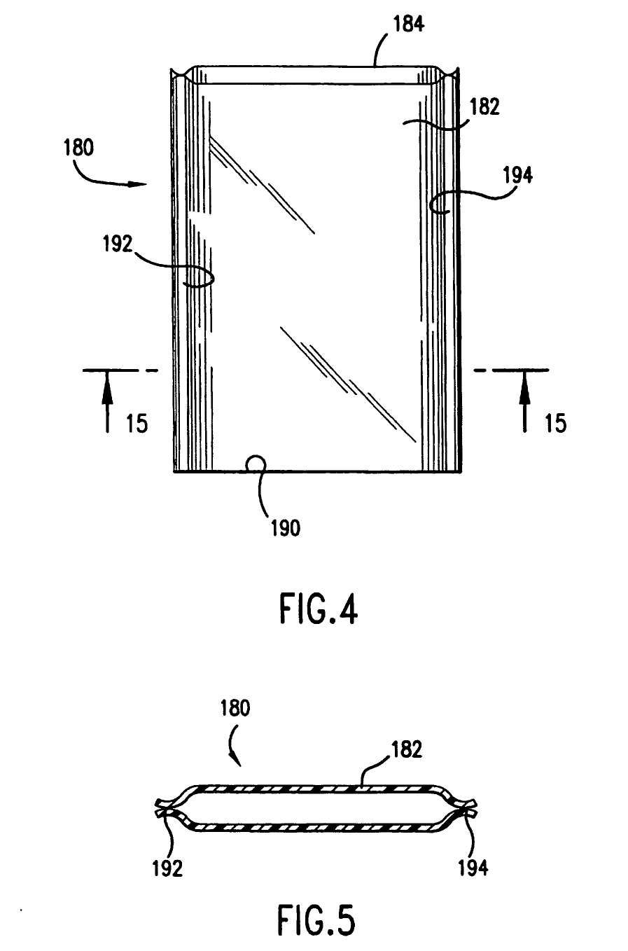

FIGS. 4 and 5 illustrate bag 180, a bag according to an alternative embodiment of the present invention. Bag 180 is a “side seal” bag. FIG. 4 illustrates a schematic of side seal bag 180, in a lay-flat view; FIG. 5 illustrates a cross-sectional view taken through section 15-15 of FIG. 4. With reference to FIGS. 4 and 5 together, side seal bag 180 comprises of bag film 182, top edge 184 defining an open mouth, bottom edge 190, first side seal 192, and second side seal 194.

The seals described herein for FIGS. 2 through 6 will typically be heat seals, using heat seal equipment well known in the art.

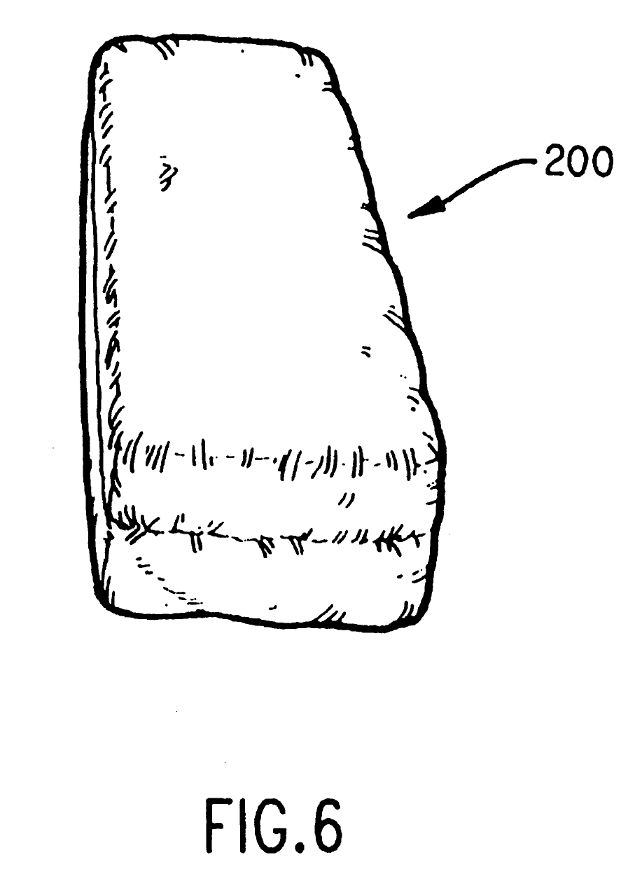

FIG. 6 illustrates a package in accordance with one embodiment of the present invention. Package 200 comprises a sealed, hermetic, vacuumized bag within which is a meat product, such as fresh red meat, such as a subprimal of beef. The sealed package is formed using a bag according to the present invention, with the product being packaged in the bag, followed by evacuation, sealing, and optionally shrinking of the bag, to result in package 200.

A bag in accordance with the invention will typically be hermetic.

Currently the process of vacuumizing and sealing is often accomplished by placing bagged articles on the platens of a rotary chamber machine. Rotary chamber machines are well known in the art. Typical are the packaging machine and machine systems developed by Furukawa Manufacturing Co., Ltd., and disclosed in U.S. Pat. No. 3,958,391 (Kujubu), U.S. Pat. No. 4,580,393 (Furukawa), and U.S. Pat. No. 4,640,081 (Kawaguchi et al.), all incorporated herein by reference in their entirety.

Alternative Bag Production

Alternatively, bags in accordance with the invention can be made by following the procedure laid out in published PCT patent publication WO 01/17853 A1 (Cryovac Australia Pty Ltd.), incorporated herein by reference in its entirety. This application teaches a method of packaging including the steps of continuously feeding a packaging material as tubing from a supply; slitting and unfolding the tubing to form a flat web of the packaging material; forming the flat web of packaging material around a fed product; longitudinally heat sealing the packaging material formed around the product; and cutting and transversely sealing the packaging material at both ends of the product to form a pouch. The interior of the pouch is evacuated prior to creating the second transverse seal, thereby creating a vacuumized bag. To implement this method, a packaging apparatus includes means for receiving packaging material continuously fed as tubing from a supply, and slitting and unfolding the tubing to form a flat web of the packaging material; calendaring means for receiving the flat web and tensioning the flat web; forming means for receiving the tensioned flat web and forming the flat web around a fed product; heat sealing means for longitudinally heat sealing the packaging material formed around the product; and end sealing means for cutting and sealing the packaging material at one or both ends of the product.

The slitting and unfolding means thus receives the continuous feed of packaging material, in tubing form, and slits and unfolds the tubing to form the flat web of the packaging material for subsequent calendaring and forming around a fed product. The longitudinal seal is created by heat sealing.

It is to be understood that variations of the present invention can be made without departing from the scope of the invention, which is not limited to the specific embodiments and examples disclosed herein, but extends to the claims presented below.

What is claimed is:

1. A package comprising:
a) a vacuumized bag, the bag made from a film comprising:
i) an outer layer comprising an olefin polymer or copolymer,
ii) an inner layer comprising an olefin polymer or copolymer,
iii) an oxygen barrier layer, disposed between the outer and inner layers, comprising a polymer or copolymer having an oxygen permeability of less than 100 cm³ O₂/m²·day·atmosphere (ASTM D3985), and
iv) an intermediate layer, disposed between the oxygen barrier layer and the inner layer, the intermediate layer comprising a polymer or copolymer,
wherein at least one of the inner layer and intermediate layer comprises a carbon dioxide scavenger; and
b) a meat product disposed in the vacuumized bag.

2. The package of claim 1 wherein the bag comprises a side seal bag comprising two bag sides each formed by a heat seal in the film, a folded bottom, and a sealed bag mouth.

3. The package of claim 1 wherein the bag comprises an end seal bag comprising two bag sides each formed by a fold in the film, a heat sealed bottom, and a sealed bag mouth.

4. The package of claim 1 wherein the carbon dioxide scavenger comprises one or more materials selected from the group consisting of metal oxide and metal hydroxide.

5. The package of claim 4 wherein the carbon dioxide scavenger comprises one or more materials selected from the group consisting of magnesium oxide, calcium oxide, zinc oxide, magnesium hydroxide, and calcium hydroxide.

6. The package of claim 1 wherein the film is crosslinked.

7. The package of claim 1 wherein the film is solid-state oriented.

8. The package of claim 1 wherein the film is a heat shrinkable film having a free shrink (ASTM D 2732-83) at a temperature of 200° F. of at least 8% in either or both of the longitudinal and transverse directions.

9. The package of claim 1 wherein the film is a tubular film.

10. The package of claim 1 wherein the inner layer is heat sealed to itself to form the sealed bag mouth.

11. A method of packaging a meat product comprising:
a) providing a bag, the bag made from a film comprising:
i) an outer layer comprising an olefin polymer or copolymer,
ii) an inner layer comprising an olefin polymer or copolymer,
iii) an oxygen barrier layer, disposed between the outer and inner layers, comprising a polymer or copolymer having an oxygen permeability of less than 100 cm³ O₂/m²·day·atmosphere (ASTM D3985), and
iv) an intermediate layer, disposed between the oxygen barrier layer and the inner layer, the intermediate layer comprising a polymer or copolymer,
wherein at least one of the inner layer and intermediate layer comprises a carbon dioxide scavenger;
b) putting a meat product into the bag through an open mouth of the bag;
c) drawing a vacuum on the bag to provide a vacuumized bag; and
d) heat sealing the open mouth of the bag to provide a hermetic, vacuumized bag.

12. The method of claim 11 wherein the bag comprises a side seal bag comprising two bag sides each formed by a heat seal in the film, a folded bottom, and a sealed bag mouth.

13. The method of claim 11 wherein the bag comprises an end seal bag comprising two bag sides each formed by a fold in the film, a heat sealed bottom, and a sealed bag mouth.

14. The method of claim 11 wherein the carbon dioxide scavenger comprises one or more materials selected from the group consisting of metal oxide and metal hydroxide.

15. The method of claim 14 wherein the carbon dioxide scavenger comprises one or more materials selected from the group consisting of magnesium oxide, calcium oxide, zinc oxide, magnesium hydroxide, and calcium hydroxide.

16. The method of claim 11 wherein the film is crosslinked.

17. The method of claim 11 wherein the film is solid-state oriented.

18. The method of claim 11 wherein the film is a heat shrinkable film having a free shrink (ASTM D 2732-83) at a temperature of 200° F. of at least 8% in either or both of the longitudinal and transverse directions.

19. The method of claim 11 wherein the film is a tubular film.

20. The method of claim 11 wherein the inner layer is heat sealed to itself to form the sealed bag mouth.
